(19) United States
(12) Patent Application Publication
(10) Pub. No.: US 2025/0264924 A1
(43) Pub. Date: Aug. 21, 2025

(54) MEASURING REAL POWER USAGE OF SOFTWARE APPLICATIONS

(71) Applicant: HSBC Global Services (UK) Limited, London (GB)

(72) Inventor: Joseph Timothy Smolcic, London (GB)

(73) Assignee: HSBC Global Services (UK) Limited, London (GB)

(21) Appl. No.: 18/581,792

(22) Filed: Feb. 20, 2024

(51) Int. Cl. G06F 1/28; G06F 9/455; G06Q 30/018

(52) U.S. Cl. CPC G06F 1/28; G06F 9/45558; G06Q 30/018; G06F 2009/45591

(57) ABSTRACT

Systems and methods for measuring the actual power draw and resulting carbon emissions of specific software applications are provided herein. A power usage module determines how much real power is being used by a cluster of servers on which there can be multiple CPUs and virtualization elements. The processor then determines how much power can be attributed to one or more software applications.

### FIELD OF THE DISCLOSURE

The present disclosure relates to systems and methods for measuring the real power draw and related carbon emissions of one or more software applications.

### BACKGROUND

Many modern businesses care about their carbon emissions but often have limited means of measuring them. For example, many contemporary applications purport to measure the carbon emissions of their customers. But often these measurements are guestimates based not on the real power draw of software applications but on referential data such as similarly sized companies or similarly organized data centers. These guestimates provide only a very general (and often incorrect) picture of a customer's actual carbon emissions. Furthermore, these measurements often fail to provide carbon emissions measurements on a more granular level, e.g., carbons emissions per team, per building, and per application.

### SUMMARY OF THE DISCLOSURE

Aspects of the disclosed embodiments include systems and methods for measuring the real power usage associated with individual software applications via their associated severs and virtualization elements which may include virtual machines and containers.

In some aspects, the techniques described herein relate to a system for measuring a power draw of an application, the system including: a power usage module; and a memory having programming instructions stored thereon, which, when executed by the power usage module, cause the system to perform operations including: retrieving one or more power usage metrics from one or more servers, wherein each server includes one or more central processing units (CPUs) and virtualization elements; determining a total power consumption of the one or more servers based on the retrieved one or more power usage metrics; allocating responsibility of the total power consumption among the one or more CPUs and virtualization elements; determining an association between the one or more CPUs and virtualization elements and one or more software applications running on the one or more CPUs and virtualization elements; generating the power usage of each of the one or more software applications based on the allocated responsibility of the total power consumption among the one or more CPUs and virtualization elements and the association between the one or more CPUs and virtualization elements and the one or more software applications running on the one or more CPU and virtualization elements; and generating, upon generating the power usage of each of the one or more software applications, one or more carbon emissions associated with each of the one or more software applications.

In some aspects, the techniques described herein relate to a method for measuring a power draw of an application, the method including: retrieving, by a power usage module, one or more power usage metrics from one or more servers, wherein each server includes one or more central processing units (CPUs) and virtualization elements; determining, by the power usage module, total power consumption of the one or more servers based on the retrieved one or more power metrics; allocating, by the power usage module, responsibility of the total power consumption among the one or more CPUs and virtualization elements; determining, by the power usage module based on this determining, an association between the one or more CPUs and virtualization elements and one or more software applications running on the one or more CPUs and virtualization elements; generating, by the power usage module, the power usage of each of the one or more software applications based on the allocated responsibility of the total power consumption among the one or more CPUs and virtualization elements and the association between the one or more CPUs and virtualization elements and the one or more software applications running on the one or more CPUs and virtualization elements; and generating, by the power usage module upon generating the power usage of each of the one or more software applications, one or more carbon emissions associated with each of the one or more software applications.

In some aspects, the techniques described herein relate to a non-transitory computer readable medium containing computer executable instructions that, when executed by a computer hardware arrangement, cause the computer hardware arrangement to perform procedures including: retrieving one or more power usage metrics from one or more servers, wherein each server includes one or more central processing units (CPUs) and virtualization elements; determining total power consumption of the one or more servers based on the retrieved one or more power metrics; allocating responsibility of the total power consumption among the one or more CPUs and virtualization elements; determining, based on allocated responsibility, an association between the one or more CPUs and virtualization elements and one or more software applications running on the one or more CPUs and virtualization elements; generating, based on the determining, the power usage of each of the one or more software applications based on the allocated responsibility of the total power consumption among the one or more CPUs and virtualization elements and the association between the one or more CPUs and virtualization elements and the one or more software applications running on the one or more CPUs and virtualization elements; and generating, upon generating the power usage of each of the one or more software applications, one or more carbon emissions associated with each of the one or more software applications.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1 illustrates a system according to example embodiments.

FIG. 2 is a diagram illustrating visualizations of power usage and carbon emissions according to example embodiments.

FIG. 3 is a sequence diagram illustrating a method according to example embodiments.

FIG. 4A is a flow diagram illustrating a method of generating a visualization of carbon emissions associated with one or more software applications, according to example embodiments.

FIG. 4B is a flow diagram illustrating a method of generating trends for power usage among software applications, according to example embodiments.

FIG. 4C is a flow diagram illustrating a method of updating the power usage metrics and generating updated visualizations, according to example embodiments.

FIG. 5 is a block diagram illustrating a system according to example embodiments.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

One or more techniques disclosed herein generally relate to systems and methods for measuring the real power draw and carbon emissions of software applications. Consumers and businesses can use these systems and methods to measure how much power is being drawn by individual software applications and not just individual servers. Thus, consumers gain a much clearer and more granular understanding of how their software applications are creating carbon emissions.

The example embodiments provide a solution to the long-standing problem of efficiently measuring, attributing, and optimizing power consumption on an application-by-application basis. In modern computing environments, especially in businesses with diverse workloads, accurately measuring and attributing power consumption to individual software applications is a complex task. Traditional power monitoring may not provide sufficient granularity, and understanding the environmental impacts in terms of carbon emissions can be challenging. Additionally, optimizing power usage to minimize environmental impact while ensuring operational efficiency presents a significant technical challenge.

To address this problem, the example embodiments present systems and methods for attributing the power draw of individual applications so that the carbon emissions of each application can be measured.

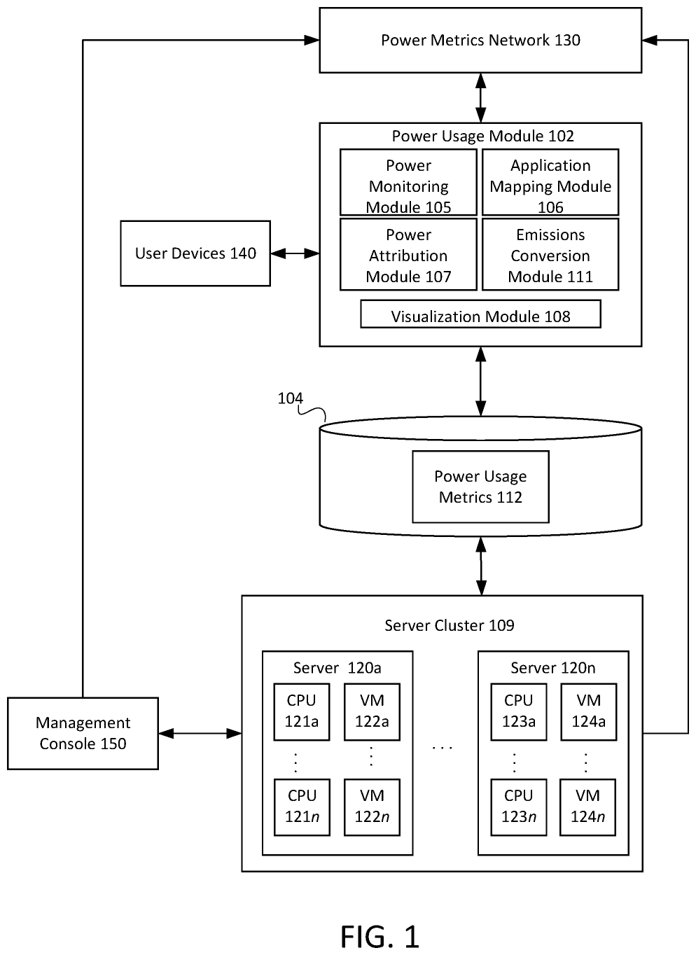

FIG. 1 is a block diagram illustrating a system, according to example embodiments. The system can include without limitation a power usage module 102, a database or data storage unit 104, a server cluster 109, a power metrics network 130, one or more user devices 140, and one or more management console 150. Generally, the power usage module 102 can connect over the power metrics network 130 to the other devices. The power usage module 102 can include a power monitoring module 105, an application mapping module 106, a power attribution module 107, and an emissions conversion module 111. Each of these modules can include readable instructions that when read by the power usage module 102 perform actions explained below.

The server cluster 109 can include multiple servers 120a-120n. Each server can include any number of computer processing units (CPUs) and virtual machines (VMs). In some embodiments, each of the VMs can have a virtual CPU capable of processing a software application. For example, server 120a can include CPUs 121a to 121n, and VMs 122a to 122n. Each software application can be used by an associated VM or container. For example, an application can execute different tasks concurrently on separate CPU cores, or an application may distribute tasks across available cores. As another example, each VM may act as an independent virtualized environment, capable of running its own applications. Applications can be used on different VMs depending on resource allocation. As the demand for an application increases or decreases, additional VMs may be provisioned to handle more loads. Additionally, the server cluster 109 may include one or more containers. Containers may be lightweight, executable unit of software that encapsulates an application's code, runtime, system tools, libraries, and settings in a standalone package. Containers interact with CPUs through the host operating system's kernel, which allocates CPU resources to containers as if they were individual, isolated operating systems. Although reference is made to virtual machines (VMs) and/or containers throughout the application, it is understood that any suitable virtualization element capable of processing a software application can be used. Each virtualization element itself may include a VM and container.

Generally, the server cluster 109 uses electrical power to function, and the power source typically comes from the electrical grid or uninterruptable power supply. When the CPUs 121a-121n and 123a-123n and associated VMs execute an application, power is consumed. Power may be delivered to the CPUs and VMs or containers via a power entry point or electrical panels where the external electrical power is brought into the facility hosting the server cluster 109. Additionally, electrical power may be distributed within the facility using power distribution units (PDUs) which capture one or more real-time power usage metrics directly from each physical server. Furthermore, the server cluster 109 may have one or more power supply units (PSUs) that may convert the incoming electrical power into the appropriate voltages needed by the server's components, including the CPU, VMs, containers, and other associated memory and storage. The power supplied to the server cluster 109 may be distributed to the various components on the server's motherboard. The CPU, VMs and/or containers may draw electrical power to execute tasks and run the software applications.

The management console 150 may monitor and measure the power usage of the server, and, in some example embodiments, may generate power usage metrics 112 based on these measurements. As a nonlimiting example, the management console 150 can include power measurement software that collects, analyzes, and/or visualizes the power data associated with each server in the server cluster. Ultimately, the management console 150 can collect power usage metrics 112 and, of its accord or through the server cluster 109, store the power usage metrics 112 in the database or data storage unit 104.

Power usage module 102 may be configured to retrieve the power usage metrics 112 and express the power usage metrics 112 in terms of how much power is used by App 1, App 2, and App 3. For example, the power usage module 102 can receive a request from the user device 140 to generate power usage metrics 112. The request may specify which software applications it would like to retrieve information on. Upon receiving the request, the power usage module 102 can retrieve the power usage metrics 112 from the database or data storage unit 104. Through the power monitoring module 105, the power usage module 102 may retrieve a constant feed of information from the management console 150 and associated software. In some example embodiments, the power usage module 102 can receive the power usage metrics 112 from the management console 150 and associated software, or from a separate server. The power usage module 102 may continuously retrieve data or retrieve data in batches. The power usage metrics 112 may represent power usage over a predetermined length of time (e.g., a month, a quarter, a year, etc.). The power usage metrics 112 may also consider a maximum power draw for the server clusters and individual CPUs and VMs.

Once the power usage metrics 112 have been retrieved, the application mapping module 106 may discern which applications execute on which servers. For example, the application mapping module 106 may discern that App 1 runs only on Server 120a and Server 120b, App 2 runs on Servers 120b, 120c, and 120f, and App 3 runs on Server 120g. In other example embodiments, the application mapping module may further discern that App 1 more specifically runs on CPUs 121a and VMs 122a. Thus, the application mapping module 106 may instruct the power usage module 102 to map each software application to a one or more servers, one or more CPUs, and one or more VMs. In some embodiments, the application mapping module 106 may map each software application only on a server rather than on a VM or a container. The action of mapping each application to its associated CPUs and VMs may be a dynamic process as applications may run on different CPUs and VMs depending on changes in time, server configuration, and power availability. Thus, it is understood that the application mapping module 106 may instruct the power usage module 102 to update its mapping of the application. Similarly, a different approach may exist for containers.

Upon mapping the software applications, next the power attribution module 107 may attribute the power usage metrics to the software applications. The power attribution module 107 considers the power usage metrics 112 and the mapping of the software applications, and then calculates how much each power is used by each software application. In some embodiments, the power attribution module 107 attributes power to the one or more software applications based on the following method: The power attribution module 107 may review the power draw of the whole data center or building associated with the server cluster 109. The power attribution module 107 may apportion non-compute based power (i.e. the power not used to run the server cluster 109, e.g. the electricity used to run the lights within the building) as additional overheads based on the total percent of compute workload an application would consume. As a nonlimiting example, a data center may draw 1000 watts, and the server cluster 109 is using 100 watts, and one application A is using 10 watts. Having observed these power draws, the remaining 900 watts is apportioned to the VMs and the applications running on the VMs. Next, the power attribution module 107 apportions the 900 watts based on the percentage of the server cluster 109's power consumption. Thus, apportionment for application A would be 10 watts divided by 100 watts to compute 10%. Then, the power attribution module multiplies 10% by the remaining 900 watts to get an additional 90 watts. Finally, the power attribution module 107 may add 10 watts to 90 watts to get 100 watts which is what the application is consuming. Any number or combination of power usage metrics can be attributed to the one or more software applications. The power attribution module 107 can dynamically adjust the power attribution upon receiving more power usage metrics 112. For example, if App 1 goes offline for a day, the power attribution module 107 will then attribute no power usage for App 1 for that specific time period.

The emissions conversion module 111 may convert the power usage into carbon emissions for each software application. Emissions conversion module 111 may convert the power usage into carbon emissions based on one or more factors, which may include, without limitation: the carbon intensity of power sources; power usage effectiveness (PUE); energy performance indicators (EPI); dynamic power management; greenhouse gas emission factors; life cycle assessment; proxy metrics and benchmarks; and other factors such as variations in energy sources, server efficiency, geographic location of the servers; carbon intensity; carbon offsetting projects; renewable energy sources; and hardware configurations. In some example embodiments, estimating the carbon emissions may include multiplying the total energy consumption by the carbon intensity associated with the power consumption. Carbon emissions may be calculated as kilograms (kg) or another appropriate metric. In some example embodiments, carbon emissions calculations may include multiplying power usage by the power usage effectiveness and the carbon intensity and multiplying the power usage by the emission factor.

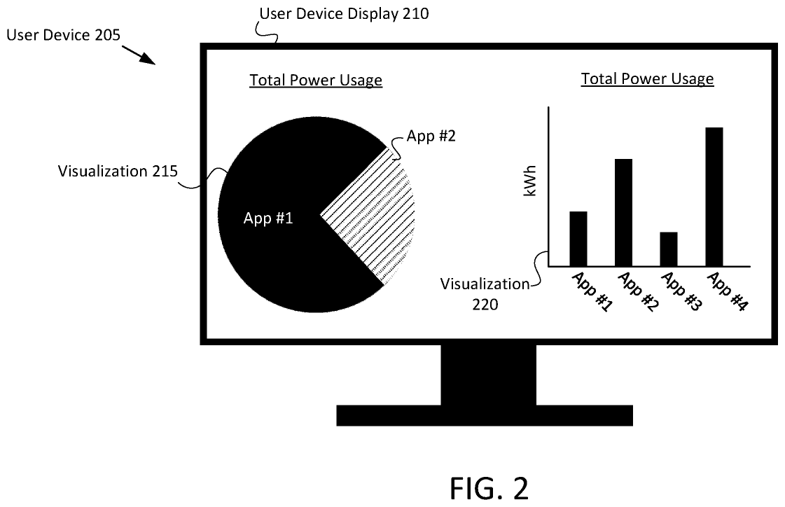

The power usage module 102 may generate one or more visualizations of the power usage metrics 112. The visualization module 108 can generate one or more visualizations regarding the power usage and associated carbon emissions of each software application further explained in FIG. 2. These visualizations may be generated by the visualization module 108 and transmitted to the user device 140 over the power metrics network 130. In some example embodiments, the visualization module 108 can even generate future power usage forecasts for each software application. For example, the visualization module 108 can analyze the historical power usage data regarding App 3, then forecast the power usage and associated carbon emissions of App 3 for the coming month, quarter, year, or any time period. The visualization module 108 can consider other factors such as scaling up or scaling down of the use of App 3 or carbon emissions restrictions such as local or national carbon emission regulations or laws.

FIG. 2 is a diagram illustrating a user device 205 with a user device display 210, according to example embodiments. User device 205 may correspond to a user device 140 discussed above in conjunction with FIG. 1. The user device 205 can be connected by a wired or wireless connection to the power usage module 102. The user device display 210 can display visualizations 215 and 220, or any number of visualizations regarding power usage and carbon emissions. The visualizations can include any kind of graph whether static or dynamic. A user can interact with the user device 205 to engage with any of the visualizations to highlight or edit information. Though FIG. 2 illustrates only a pie chart and a bar chart, it is understood the other visualizations not pictured in FIG. 2 are considered in the exemplary embodiments, including without limitation: line charts; scatter plots; histograms; heat maps; bubble charts; stacked area chart; box plot or box-and-whisker plot; and tree map.

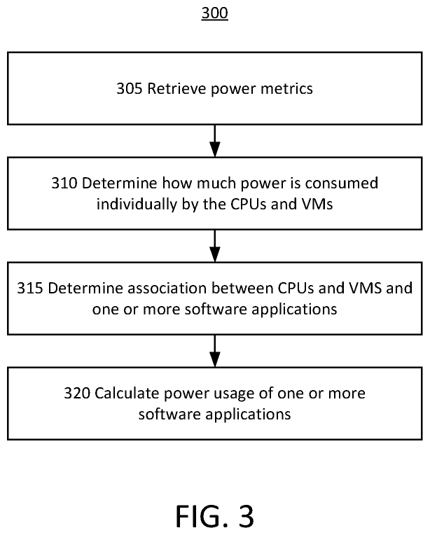

FIG. 3 is a flow diagram illustrating a method 300 according to an example embodiment. Each action in the method can be performed by the power usage module 102. Though the blocks are arranged in a certain order, it is understood that the method can proceed in a different order than pictures.

At step 305, the power usage module 102 can retrieve one or more power usage metrics 112 regarding one or more servers 120a-120n, CPUs 121a-121n and 123a-123n, VMs 122a-122n and 124a-124n, and associated software applications. The power usage metrics 112 can be retrieved from a database or data storage unit 104. In other example embodiments, the power usage module 102 can receive the power usage metrics 112 from management console 150 and software or some related server.

At step 310, the power usage module 102 can determine how much power is consumed by the server cluster 109, individual servers, CPUs 121a-121n and 123a-123n, and VMs 122a-122n and 124a-124n based on the retrieved power metrics. In some embodiments, power usage module 102 can determine how much power is consumed by dividing up the total power consumed by the server cluster 109, then dividing the total power amongst the CPUs 121a-121n and 123a-123n and VMs 122a-122n and 124a-124n. Although reference is made to virtual machines (VMs) throughout the application, it is understood that any suitable virtualization element capable of processing a software application can be used. Each virtualization element itself may include a VM and a container.

At step 315, the power usage module 102 can determine an association between the CPUs 121a-121n and 123a-123n and VMs 122a-122n and 124a-124n and the one or more software applications in question. For example, the power usage module 102 may determine that App 1 is run on VM 122a, App 2 run on VM 122b, and so on.

At step 320, the power usage module 102 can calculate the power usage of one or more software applications. That is, the power usage module 102 can divide up the total power of the server cluster 109 into individual CPUs and VMs, then further divide up the power into software applications running on those CPUs and VMs. As a result, the power usage module 102 may calculate the power usage of each software application. The power usage can be defined without limitation as watts, kilowatts, kilowatt-hours, or some other appropriate measurement.

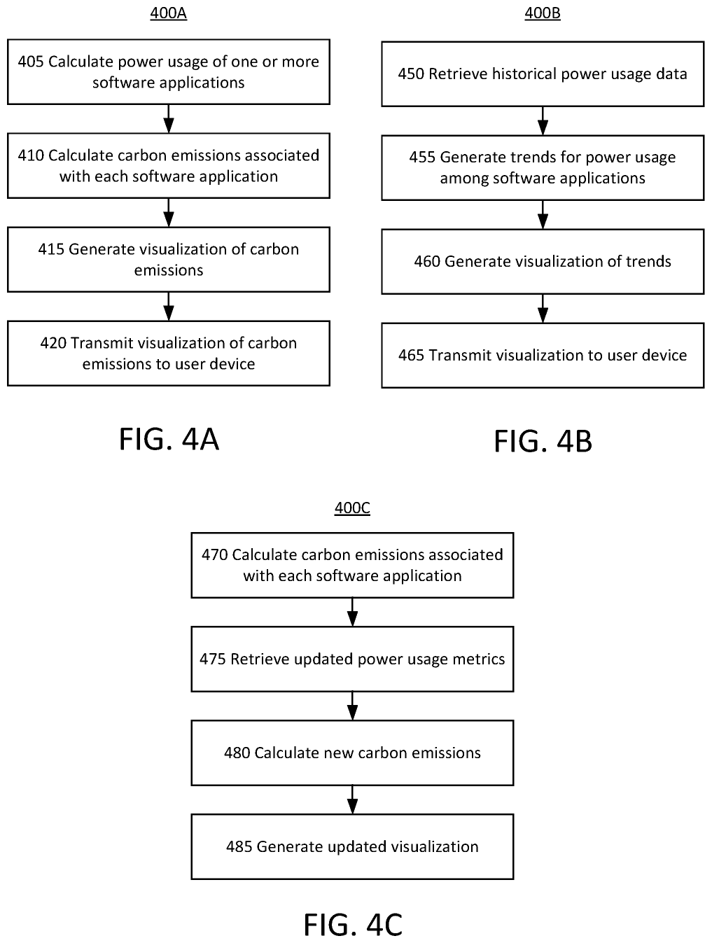

FIG. 4A is a flow diagram illustrating a method 400A of generating a visualization of carbon emissions associated with one or more software applications, according to example embodiments.

At step 405, power usage module 102 calculates the power usage of one or more software applications as explained in FIGS. 1 and 3. The power usage module 102 can calculate the power usage of one or more software applications. That is, the power usage module 102 can divide up the total power of the server cluster 109 into individual CPUs and VMs, then further divide up the power into software applications running on those CPUs and VMs. As a result, the power usage module 102 may calculate the power usage of each software application. The power usage can be defined without limitation as watts, kilowatts, kilowatt-hours, or some other appropriate measurement. Although reference is made to virtual machines (VMs) throughout the application, it is understood that any suitable virtualization element capable of processing a software application can be used. Each virtualization element itself may include a VM and a container.

At step 410, the power usage module 102 can calculate the carbon emissions associated with each software application. In some example embodiments, estimating the carbon emissions can include multiplying the total energy consumption by the carbon intensity associated with the power consumption. Carbon emissions may be calculated as kilograms (kg) or other appropriate measurement. In other example embodiments, carbon emissions calculations may include multiplying power usage by the power usage effectiveness and the carbon intensity; and multiplying the power usage by the emission factor. Other factors may be considered including without limitation: power usage effectiveness (PUE); energy performance indicators (EPI); dynamic power management; greenhouse gas emission factors; life cycle assessment; proxy metrics and benchmarks; and other factors such as variations in energy sources, server efficiency, geographic location of the servers; carbon intensity; and hardware configurations.

At step 415, the power usage module 102 can generate one or more visualizations of carbon emissions explained further with reference to FIGS. 1 and 2. For example, the visualizations can include static or dynamic visualizations of power usage and carbon emissions over a predetermined time period. In action 420, the power usage module 102 can transmit the visualizations to a user device 140 where the visualizations can be viewed on a display. This user device 140 can be the same user device 140 that initially requested the power usage and carbon emission visualizations from the power usage module 102.

FIG. 4B is a flow diagram illustrating a method 400B of generating trends for power usage among software applications, according to example embodiments. In some example embodiments the power usage module 102 may generate historical trend data regarding the power usage and associated carbon emissions of each software application.

At step 450, the power usage module 102 can retrieve one or more historical power usage data, such as the historical power usage and carbon emissions of each software application over the last three years. This data can be retrieved from a database or data storage unit 104. In other example embodiments, the data can request and received from power measurement software.

At step 455, the power usage module 102 can generate one or more trends for power usage among the software applications. For example, the power usage module 102 can determine a trend which reveals that App 1's power usage and carbon emissions have gone down over the last three years, whereas App 2's power usage and carbon emissions have gone up. The power usage module 102 may use one or more statistical analysis modules sufficient to generate these trends.

At step 460, the power usage module 102 may generate one or more visualizations of these trends, such as without limitations line charts. These visualizations may incorporate any number of trends from any number of applications.

At step 465, the power usage module 102 can transmit the visualizations to the user device 140 over a wired or wireless power metrics network 130.

FIG. 4C is a flow diagram illustrating a method 400C of updating the power usage metrics 112 and generating updated visualizations, according to example embodiments. In some example embodiments the power usage and carbon emissions determinations may be updated in response to, without limitation, a change in carbon intensity associated with the geographic location of the server cluster 109.

At step 470, the power usage module 102 may calculate carbon emissions or power usage associated with each software application. In some example embodiments, estimating the carbon emissions can include multiplying the total energy consumption by the carbon intensity associated with the power consumption. Carbon emissions may be calculated as kilograms (kg) or other appropriate measurement. In other example embodiments, carbon emissions calculations may include multiplying power usage by the power usage effectiveness and the carbon intensity; and multiplying the power usage by the emission factor. Other factors may be considered including without limitation: PUE; EPI; dynamic power management; greenhouse gas emission factors; life cycle assessment; proxy metrics and benchmarks; and other factors such as variations in energy sources, server efficiency, geographic location of the servers; carbon intensity; and hardware configurations.

In action 475, the power usage module 102 can retrieve or receive one or more updated power usage metrics. The metrics can be retrieved from a database or data storage unit 104 which may be separate from or integrated into the power usage module 102. In other example embodiments, the power usage module 102 may receive. This action may be preceded by a specific request from a user device 140 (e.g., a request for updated data) or a significant change in power usage or carbon emissions. For example, the power usage module 102 may receive a notification that the power usage or carbon emissions associated with App 1 have changed significantly over the past month, in which a new and updated determination is necessary. Other significant changes can include changes in power or carbon emissions standards, regulations, or laws; a sudden drop in power usage that may be caused by a blackout or hardware malfunction; a recent carbon offsetting project; updated metrics from one or more renewable energy sources; or sudden spike in power usage that may indicate a surge.

At step 480, the power usage module 102 can calculate the new carbon emissions associated with the one or more software applications. From these new calculations, the power usage module 102 can generate one or more updated visualizations in action 485. These actions may then transmit to a user device 140 over a wired or wireless network 130.

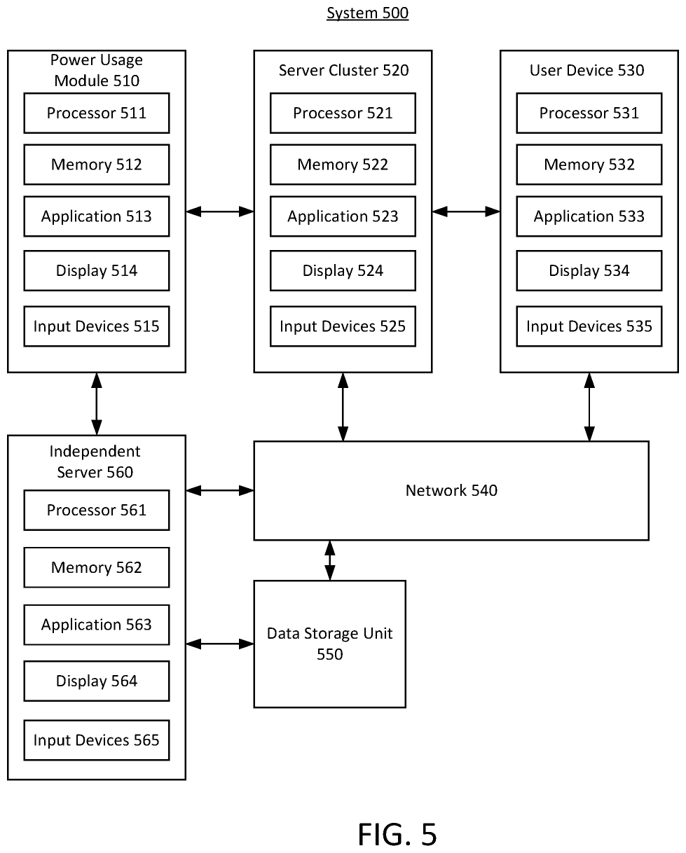

FIG. 5 illustrates a system 500 according to example embodiments. The system 500 may comprise a power usage module 510, a server cluster 520, a user device 530, a network 540, a database or data storage unit 550, and a server 560. Although FIG. 1 illustrates single instances of components of system 500, system 500 may include any number of components.

The system can include one or more power usage modules 510. The power usage module 510 may include a processor 511, a memory 512, and an application 513. The processor 511 may be a processor, a microprocessor, or other processor, and the power usage module 510 may include one or more of these processors. The processor 511 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 511 may be coupled to the memory 512. The memory 512 may be a read-only memory, write-once read-multiple memory or read/write memory, e.g., RAM, ROM, and EEPROM, and the power usage module 510 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 512 may be configured to store one or more software applications, such as the application 513, and other data, such as user's private data and financial account information.

The application 513 may comprise one or more software applications, such as a mobile application and a web browser, comprising instructions for execution on the power usage module 510. In some examples, the power usage module 510 may execute one or more applications, such as software applications, that enable, for example, network communications with one or more components of the system 500, transmit and/or receive data, and perform the functions described herein. Upon execution by the processor 511, the application 513 may provide the functions described in this specification, specifically to execute and perform the steps and functions in the process flows described below. Such processes may be implemented in software, such as software modules, for execution by computers or other machines. The application 513 may provide graphical user interfaces (GUIs) through which a user may view and interact with other components and devices within the system 500. The GUIs may be formatted, for example, as web pages in HyperText Markup Language (HTML), Extensible Markup Language (XML) or in any other suitable form for presentation on a display device depending upon applications used by users to interact with the system 500.

The power usage module 510 may further include a display 514 and input devices 515. The display 514 may be any type of device for presenting visual information such as a computer monitor, a flat panel display, and a mobile device screen, including liquid crystal displays, light-emitting diode displays, plasma panels, and cathode ray tube displays. The input devices 515 may include any device for entering information into the power usage module 510 that is available and supported by the power usage module 510, such as a touchscreen, keyboard, mouse, cursor-control device, touchscreen, microphone, digital camera, video recorder or camcorder. These devices may be used to enter information and interact with the software and other devices described herein.

The system can include one or more sever clusters 520. The sever cluster 520 may include a processor 521, a memory 522, and an application 523. The processor 521 may be a processor, a microprocessor, or other processor, and the server cluster 520 may include one or more of these processors. The processor 521 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 521 may be coupled to the memory 522. The memory 522 may be a read-only memory, write-once read-multiple memory or read/write memory, e.g., RAM, ROM, and EEPROM, and the server cluster 520 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 522 may be configured to store one or more software applications, such as the application 523, and other data, such as user's private data and financial account information.

The application 523 may comprise one or more software applications, such as a mobile application and a web browser, comprising instructions for execution on the server cluster 520. In some examples, the server cluster 520 may execute one or more applications, such as software applications, that enable, for example, network communications with one or more components of the system 500, transmit and/or receive data, and perform the functions described herein. Upon execution by the processor 521, the application 523 may provide the functions described in this specification, specifically to execute and perform the steps and functions in the process flows described below. Such processes may be implemented in software, such as software modules, for execution by computers or other machines. The application 523 may provide graphical user interfaces (GUIs) through which a user may view and interact with other components and devices within the system 500. The GUIs may be formatted, for example, as web pages in HyperText Markup Language (HTML), Extensible Markup Language (XML) or in any other suitable form for presentation on a display device depending upon applications used by users to interact with the system 500.

The server cluster 520 may further include a display 524 and input devices 525. The display 524 may be any type of device for presenting visual information such as a computer monitor, a flat panel display, and a mobile device screen, including liquid crystal displays, light-emitting diode displays, plasma panels, and cathode ray tube displays. The input devices 525 may include any device for entering information into the server cluster 520 that is available and supported by the server cluster 520, such as a touchscreen, keyboard, mouse, cursor-control device, touchscreen, microphone, digital camera, video recorder or camcorder. These devices may be used to enter information and interact with the software and other devices described herein.

The system can include one or more user devices 530. The user device 530 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 530 may include a processor 531, a memory 532, and an application 533. The processor 531 may be a processor, a microprocessor, or other processor, and the user device 530 may include one or more of these processors. The processor 531 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 531 may be coupled to the memory 532. The memory 532 may be a read-only memory, write-once read-multiple memory or read/write memory, e.g., RAM, ROM, and EEPROM, and the user device 530 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 532 may be configured to store one or more software applications, such as the application 533, and other data, such as user's private data and financial account information.

The application 533 may comprise one or more software applications, such as a mobile application and a web browser, comprising instructions for execution on the user device 530. In some examples, the user device 530 may execute one or more applications, such as software applications, that enable, for example, network communications with one or more components of the system 500, transmit and/or receive data, and perform the functions described herein. Upon execution by the processor 531, the application 533 may provide the functions described in this specification, specifically to execute and perform the steps and functions in the process flows described below. Such processes may be implemented in software, such as software modules, for execution by computers or other machines. The application 533 may provide graphical user interfaces (GUIs) through which a user may view and interact with other components and devices within the system 500. The GUIs may be formatted, for example, as web pages in HyperText Markup Language (HTML), Extensible Markup Language (XML) or in any other suitable form for presentation on a display device depending upon applications used by users to interact with the system 500.

The user device 530 may further include a display 534 and input devices 535. The display 534 may be any type of device for presenting visual information such as a computer monitor, a flat panel display, and a mobile device screen, including liquid crystal displays, light-emitting diode displays, plasma panels, and cathode ray tube displays. The input devices 535 may include any device for entering information into the user device 530 that is available and supported by the user device 530, such as a touchscreen, keyboard, mouse, cursor-control device, touchscreen, microphone, digital camera, video recorder or camcorder. These devices may be used to enter information and interact with the software and other devices described herein.

System 500 may include one or more networks 540. In some examples, the network 540 may be one or more of a wireless network, a wired network or any combination of wireless network and wired network and may be configured to connect the user device 530, the server 560, the power usage module 510, and the database or data storage unit 550. For example, the network 540 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 540 may include, without limitation, telephone lines, fiber optics, IEEE Ethernet 902.3, a wide area network, a wireless personal area network, a LAN, or a global network such as the Internet. In addition, the network 540 may support an Internet network, a wireless communication network, a cellular network, or the like, or any combination thereof. The network 540 may further include one network, or any number of the exemplary types of networks mentioned above, operating as a stand-alone network or in cooperation with each other. The network 540 may utilize one or more protocols of one or more network elements to which they are communicatively coupled. The network 540 may translate to or from other protocols to one or more protocols of network devices. Although the network 540 is depicted as a single network, it should be appreciated that according to one or more examples, the network 540 may comprise a plurality of interconnected networks, such as, for example, the Internet, a service provider's network, a cable television network, corporate networks, such as credit card association networks, and home networks. The network 540 may further comprise, or be configured to create, one or more front channels, which may be publicly accessible and through which communications may be observable, and one or more secured back channels, which may not be publicly accessible and through which communications may not be observable.

System 500 may include a database or data storage unit 550. The database or data storage unit 550 may be one or more databases configured to store data, including without limitation, private data of users, financial accounts of users, identities of users, transactions of users, and certified and uncertified documents. The database or data storage unit 550 may comprise a relational database, a non-relational database, or other database implementations, and any combination thereof, including a plurality of relational databases and non-relational databases. In some examples, the database or data storage unit 550 may comprise a desktop database, a mobile database, or an in-memory database. Further, the database or data storage unit 550 may be hosted internally by the server 560 or may be hosted externally of the server 560, such as by a server, by a cloud-based platform, or in any storage device that is in data communication with the server 560.

The system can include a server 560. The server 560 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. The server may be a combination of one or more cloud computing systems such as public clouds, private clouds, and hybrid clouds.

The server 560 may include a processor 561, a memory 562, and an application 563. The processor 561 may be a processor, a microprocessor, or other processor, and the server 560 may include one or more of these processors. The processor 561 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 561 may be coupled to the memory 562. The memory 562 may be a read-only memory, write-once read-multiple memory or read/write memory, e.g., RAM, ROM, and EEPROM, and the server 560 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 562 may be configured to store one or more software applications, such as the application 563, and other data, such as user's private data and financial account information.

The application 563 may comprise one or more software applications, such as a mobile application and a web browser, comprising instructions for execution on the server 560. In some examples, the server 560 may execute one or more applications, such as software applications, that enable, for example, network communications with one or more components of the system 500, transmit and/or receive data, and perform the functions described herein. Upon execution by the processor 561, the application 563 may provide the functions described in this specification, specifically to execute and perform the steps and functions in the process flows described below. Such processes may be implemented in software, such as software modules, for execution by computers or other machines. The application 563 may provide graphical user interfaces (GUIs) through which a user may view and interact with other components and devices within the system 500. The GUIs may be formatted, for example, as web pages in HyperText Markup Language (HTML), Extensible Markup Language (XML) or in any other suitable form for presentation on a display device depending upon applications used by users to interact with the system 500.

The server 560 may further include a display 564 and input devices 565. The display 564 may be any type of device for presenting visual information such as a computer monitor, a flat panel display, and a mobile device screen, including liquid crystal displays, light-emitting diode displays, plasma panels, and cathode ray tube displays. The input devices 565 may include any device for entering information into the server 560 that is available and supported by the server 560, such as a touchscreen, keyboard, mouse, cursor-control device, touchscreen, microphone, digital camera, video recorder or camcorder. These devices may be used to enter information and interact with the software and other devices described herein.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A system for measuring a power draw of an application, the system comprising:
a power usage module; and
a memory having programming instructions stored thereon, which, when executed by the power usage module, cause the system to perform operations comprising:
retrieving one or more power usage metrics from one or more servers, wherein each server comprises one or more central processing units (CPUs) and virtualization elements;
determining a total power consumption of the one or more servers based on the retrieved one or more power usage metrics;
allocating responsibility of the total power consumption among the one or more CPUs and the virtualization elements;
determining an association between the one or more CPUs and the virtualization elements and one or more software applications running on the one or more CPUs and the virtualization elements;
generating a power usage of each of the one or more software applications based on the allocated responsibility of the total power consumption among the one or more CPUs and the virtualization elements and the association between the one or more CPUs and the virtualization elements and the one or more software applications running on the one or more CPUs and the virtualization elements; and
upon generating the power usage of each of the one or more software applications, generating one or more carbon emissions associated with each of the one or more software applications.

2. The system of claim 1, wherein the system further comprises a power management console that captures one or more real-time power usage metrics from the one or more servers.

3. The system of claim 1, wherein the one or more power usage metrics comprises historical data and real-time data associated with the one or more servers.

4. The system of claim 1, wherein the operations further comprise:
updating the power usage of each of the one or more software applications in response to at least a change in application deployment or server configuration in real time.

5. The system of claim 1, wherein the operations further comprise:
generating historical power usage trends for the one or more software applications.

6. The system of claim 1, wherein the operations further comprise:
generating, based on the generated power usage of the one or more software applications, one or more future power usage forecasts for the one or more software applications.

7. The system of claim 1, wherein the operations further comprise:
generating one or more graphical visualizations of the generated power usage of the one or more software applications.

8. The system of claim 7, wherein the operations further comprise generating one or more future forecasts of power usage of each of the one or more software applications.

9. The system of claim 1, wherein the generating of the one or more carbon emissions comprises multiplying the power usage associated with each software application by a predetermined carbon intensity.

10. A method for measuring a power draw of an application, the method comprising:
retrieving, by a power usage module, one or more power usage metrics from one or more servers, wherein each server comprises one or more central processing units (CPUs) and virtualization elements;
determining, by the power usage module, total power consumption of the one or more servers based on the retrieved one or more power metrics;
allocating, by the power usage module, responsibility of the total power consumption among the one or more CPUs and the virtualization elements;
determining, by the power usage module based on this determining, an association between the one or more CPUs and the virtualization elements and one or more software applications running on the one or more CPUs and the virtualization elements;
generating, by the power usage module, a power usage of each of the one or more software applications based on the allocated responsibility of the total power consumption among the one or more CPUs and the virtualization elements and the association between the one or more CPUs and the virtualization elements and the one or more software applications running on the one or more CPUs and the virtualization elements; and
upon generating the power usage of each of the one or more software applications, generating, by the power usage module, one or more carbon emissions associated with each of the one or more software applications.

11. The method of claim 10, further comprising generating, by the power usage module, one or more future forecasts of power usage of each of the one or more software applications.

12. The method of claim 10, wherein the power usage module considers a geographical location of each of the one or more servers and carbon intensity data in calculating the one or more carbon emissions.

13. The method of claim 10, wherein the method further comprises presenting the generated power usage and carbon emissions calculations to a graphical user interface associated with a user device.

14. The method of claim 10, wherein generating the one or more carbon emissions comprises:
multiplying the total power consumption by a carbon intensity associated with the power consumption, wherein carbon emissions are calculated as kilograms (kg).

15. The method of claim 10, wherein the generation of the one or more carbon emissions considers at least carbon offsetting projects and power received from renewable energy sources.

16. The method of claim 10, wherein the generated power usage considers a maximum power draw of the one or more servers.

17. The method of claim 10, wherein the method further comprises generating, upon calculating the power usage of the one or more software applications, one or more graphical visualizations of the calculated power usage of the one or more software applications.

18. The method of claim 17, wherein the method further comprises transmitting the one or more graphical visualizations over a power metrics network.

19. The method of claim 10, wherein the method further comprises receiving real-time power data from one or more hardware power measurement units associated with the one or more servers.

20. A non-transitory computer readable medium containing computer executable instructions that, when executed by a computer hardware arrangement, cause the computer hardware arrangement to perform procedures comprising:
retrieving one or more power usage metrics from one or more servers, wherein each server comprises one or more central processing units (CPUs) and virtualization elements;
determining total power consumption of the one or more servers based on the retrieved one or more power metrics;
allocating responsibility of the total power consumption among the one or more CPUs and the virtualization elements;
determining, based on allocated responsibility, an association between the one or more CPUs and the virtualization elements and one or more software applications running on the one or more CPUs and the virtualization elements;
generating, based on the determining, a power usage of each of the one or more software applications based on the allocated responsibility of the total power consumption among the one or more CPUs and the virtualization elements and the association between the one or more CPUs and the virtualization elements and the one or more software applications running on the one or more CPUs and the virtualization elements; and
upon generating the power usage of each of the one or more software applications, generating one or more carbon emissions associated with each of the one or more software applications.
